(19) United States
(12) Patent Application Publication
(10) Pub. No.: US 2009/0228732 A1
(43) Pub. Date: Sep. 10, 2009

(54) METHOD FOR SYNCHRONIZATION OF NETWORK NODES

(75) Inventors: Wolfgang Budde, Aachen (DE); Tom Suters, Nuenen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,442

(22) PCT Filed: Mar. 10, 2006
(86) PCT No.: PCT/IB06/50759

§ 371 Date: Sep. 12, 2007

(30) Foreign Application Priority Data
Mar. 18, 2005 (EP) 05102185.5

(51) Int. Cl. G06F 15/16; G06F 1/12

(52) U.S. Cl. 713/400; 709/248

(57) ABSTRACT

Method for synchronization of network nodes in a LAN (10) including a central network master-node (11) and a plurality of synchronization domains (20, 30), each synchronization subnetwork (20,30) includes a synchronization submaster (21, 31) and at least one synchronization slave-node (22, 23; 32, 33), the method comprising the following steps: setting up or change a multicast group for each synchronization domain (20, 30), wherein a multicast group includes MAC addresses of all synchronization slaves (22, 23; 32, 33) of the synchronization domain (20, 30); transmitting a first synchronization message (12) at time n from the central master-node (11) to all other network nodes (21, 22, 23; 31, 32, 33); receiving the first synchronization message in all other network nodes (21, 22, 23; 31, 32, 33); capturing a local clock value A_{x,y}(n) at receiving the first synchronization message (12) in each other network nodes (21, 22, 23; 31, 32, 33); multicasting a second synchronization message (13) by the synchronization master-nodes (21, 31) to the synchronization slaves-nodes (22, 23; 32, 33) at time within the associated synchronization domain (20, 30), wherein the second synchronization message (13) includes the local clock value Ax,o(n) of the associated synchronization master-node (21, 31) of the synchronization slave-nodes (22, 23; 32, 33) within the respective synchronization domain (20, 30); receiving the second synchronization message (13) in the synchronization slave-nodes (22, 23; 32, 33) including the clock value A_{x,o}(n) of the associated synchronization master-node (21, 31); comparing the local clock value A_{xy}(n) captured at receiving of the first synchronization message (12) with the clock value A_{x,o}(n) received with the second synchronization message (13); and adjusting the local clock in the synchronization slave-node (22, 23; 32, 33) depending on the comparison result.

The Invention relates to a method for synchronization of network nodes in a local area network including a central network master-node and a plurality of synchronization domains. It further relates to a communication network including a central master-node of the network and a plurality of synchronization domains.

High precision clock synchronization is one of the most basic requirements in distributed real-time systems. Due to the unavoidable drift of local clocks within network nodes, a common time base among different nodes can be achieved only by means of a clock synchronization protocol.

A non-synchronized network is subject to clock jitter. Such networks are e.g. used for streaming of audio/video (A/V) contents, wherein a trained ear is able to hear a jitter of +/−1.5 μs. A further reason for a highly synchronized system is that the amount of discarded data will increase if the clock shift between communicating nodes increases, resulting in a high inefficiency.

The transmission of data streams (e.g. Audio/Video streams) in networks requires synchronization between the stream source, the ‘server’ and the stream sink, the ‘renderer’, in order to avoid buffer over- or underruns within the nodes. One solution (as in IEEE1394) is to synchronize all nodes existing in the WLAN, but this poses unnecessary high demands in terms of accuracy on the network.

The WO 03/075488 describes a clock synchronization mechanism for wireless local area networks (WLANs). A plurality of non-master nodes is coupled via a wireless network. To synchronize all non-master nodes it is proposed to define one of the non-master nodes as master time base, which serves as master clock against which all non-master local time bases of the non-master nodes are synchronized.

The reception of a dedicated synchronization message transmitted by the master node defined as master time base is used as a network-wide synchronization event, which is then used to adjust local clocks in non-master nodes. However, as mentioned above, this synchronization mechanism causes a very stringent signaling, because also non-master nodes are synchronized which are currently not participating in any streaming traffic. Furthermore, the need to synchronize a large number of network nodes results in complexity increase of the synchronization algorithm, and typically increases the latency until a stable synchronized state is achieved.

Therefore it is an object of the invention to provide a method and a communication network for synchronizing network nodes, which are simple and smart, allowing a reduction of the total signaling effort, simplifying the clock synchronization algorithm and lead to low synchronization latency.

The invention bases on the thought that synchronization of only those nodes is necessary which are involved in the transmission of a particular data stream. It is further based on the thought that there are several nodes within a LAN that have no interaction with synchronization requirements among each other. Accordingly it is not required to synchronize all nodes on the same time base. The synchronization of sub-networks with few network nodes can be more easily, more accurate and is faster.

The object is solved by a method comprising the following steps: setting up or changing a multicast group for each synchronization domain containing MAC addresses of all synchronization nodes in a synchronization domain; each synchronization domain comprises exactly one synchronization master node; transmitting a first synchronization message at time n from a central master-node of the network to all other network nodes; receiving the first synchronization message in all other network nodes; capturing a local clock value at receiving the first synchronization message in each other network nodes; multicasting a second synchronization message by the synchronization master-nodes to the synchronization slaves-nodes within the associated synchronization domain, wherein the second synchronization message includes the local clock value of the associated synchronization master-node of the synchronization slave-nodes within the respective synchronization domain captured when receiving the first synchronization message; receiving the second synchronization message in the synchronization slave-nodes including the clock value of the associated synchronization master-node; comparing the local clock value captured at receiving of the first synchronization message by the slave nodes with the clock value received with the second synchronization message; and adjusting the local clock in the synchronization slave-nodes depending on the comparison result.

The present invention, in its broadest application, is directed to a clock synchronization protocol for synchronizing clocks of nodes via a local area network (e.g., 802.11 network). The present invention requires that networks employing the method of the invention are controlled by a central master node, which can access all other or non central-master nodes. The central master node controls the operation of the network; this is the case e.g. in an IEEE 802.11 wireless local area network. The present invention further requires that systems employing the method of the invention operate in accordance with broadcast or multicast communication principles. That is, the present invention is intended for use in those systems in which one or more master nodes broadcast messages including data to a plurality of sets of slave nodes in the network. The central master node is responsible of controlling the entire network. The central master node schedules e.g. access to the shared medium (802.11 point coordination function or 802.11e hybrid coordination function), manages network security and the like. The aforementioned master nodes have as their scope only a part of the entire network. This part of the network is characterized by the fact that its network nodes need to be synchronized with each other, and can thus be called a synchronization domain. Application of the method has potential widespread use whereby the nodes may be associated with any wired and/or wireless communication system. For example, the nodes may be associated with well-known wired communication systems, such as Ethernet or 802.3. Alternatively, the nodes may be associated with wireless communication systems. For example, the principles of the present invention will be described herein in the context of nodes wirelessly coupled via an 802.11 wireless local area network (WLAN). It is to be appreciated, however, that the wireless embodiment is a non-limiting exemplary embodiment.

A network root- or central master-node (e.g. in IEEE802.11, HiperLAN/2) within the WLAN serves as access point. According to the present invention the central master node in form of an access point is used for transmitting said first synchronization message to all other network nodes in order to create a synchronization event for use within the synchronization domains. This synchronization event is represented by the reception of said first synchronization message. In particular the clock value of the synchronization master nodes captured when receiving said first synchronization message is used as synchronization base within the associated synchronization domains. This clock value of a synchronization master node is distributed by the synchronization master nodes by means of a multicast message to the respective slave nodes only within that synchronization domain. The multicast message is represented by the second synchronization message. Thus the synchronization is performed only within a synchronization domain. It is not required to synchronize all network nodes connected to the WLAN to the same time base. So the signaling effort is reduced, the complexity of the synchronization algorithm (e.g. the averaging function) is significantly reduced, and low-latency convergence can be expected. Further the flexibility depending on the kind of data could be considered during synchronization. The synchronization is performed for a synchronization domain only if there is a data stream, which is to be transmitted from a master node to at least one slave node within a synchronization domain.

Before transmitting the first synchronization message, the multicast groups need to be determined. A multicast group includes all nodes of a synchronization domain. This could be achieved by analyzing the source-renderer relations (as e.g. set up using UPnP, Universal-Plug‘n’Play) within the WLAN. A synchronization domain is set up by assigning a multicast MAC address to all member nodes of this synchronization domain, and selecting one network node within the synchronization domain as synchronization master (this may beneficially be the source of the data stream, but also another node can be selected as synchronization master). The setup is performed by an upper layer protocol, e.g. within the central master node, the synchronization master node or another node able to run such setup protocol. By means of the MAC addresses it is determined which slave nodes belong to which synchronization domain. For multicasting a message, the synchronization master node transmits its message into its synchronization domain, wherein due to the used MAC address of this message the slave nodes are able to receive this message. There are two possibilities of multicasting the message including the clock value of the synchronization master node. In a first one the central master node, which acts as access point, supports the multicast traffic by receiving the messages to be multicasted into a certain multicast group from the stream source, and distributing (i.e. forwarding) this message to the multicast group (destination address of this message is the multicast group address). However a further possibility is to multicast the second synchronization message directly from the synchronization master nodes to the associated slave-nodes within the synchronization domain. By directly multicasting the second synchronization message the central master-nodes is not necessary to distribute the second synchronization message. This will save time and some amount of traffic within the network.

The present invention has the advantage, that the central master node of the network does only start the synchronization procedure by transmitting a first synchronization message. This first synchronization message could be empty. However after receiving the first synchronization message in all nodes, each node is urged to capture its clock value. This will be done in all nodes belonging to the central master node. Since all synchronization master nodes within the plurality of synchronization domains know that they act as synchronization master node within a synchronization domain, only the synchronization master nodes multicast their clock value captured at reception of said first synchronization message to the synchronization-slave nodes within their associated synchronization domain. In other words, the synchronization master-node distributes the respective clock values directly or via the central master-node indirectly to the assigned slave nodes by using the ability of multicasting a message. This message is the second synchronization message. The second synchronization message including the respective clock value of the synchronization master node will be transmitted only to those slave nodes within the assigned synchronization domain.

Accordingly, the present invention proposes a new clock synchronizing mechanism that can be implemented in various communication environments, including specifically 802.11 networks.

The synchronization method according to the present invention provides a solution for multiple synchronization domains in a network. The requirement for multiple synchronization domains stems from the fact that each server-renderer relation in a network has its own timing parameters, and if multiple server-renderer relations are operational at the same time, a multitude of timing relations need to be maintained. The solution as known from the prior art and mentioned above, is to synchronize all streams to only one synchronization master, but this of course would complicate the synchronization requirements significantly. This problem is solved by the inventive method by allowing a plurality of synchronization domains, in which a single synchronization master-node and a number of slave-nodes (typically the renderer(s) of the stream originating typically from the master) run a synchronized streaming application. So only for that streaming application the nodes within a synchronization domain need to be synchronized. After finishing the streaming application, the nodes within the synchronization domain could be allocated to a different synchronization domain. It is also possible that a synchronization master node will act as slave node after finishing the streaming application. The same applies for a slave node correspondingly. It is even possible that during a stream transmission, the role of the synchronization master is handed over from one node of the associated synchronization domain to another; this may become necessary if the communication link quality of the initially chosen synchronization master node degrades, and thus another node with better link quality is better suited to perform this task.

Further advantages will be provided by the dependent claims.

In a preferred embodiment of the invention the capturing of the clock value in the nodes is performed upon occurrences of last symbol on air (LSOA). The observation of this event can be achieved using a service defined for 802.11e, a variant of the 802.11 family of standards that provides superior QoS functionality.

It is further preferred that the central master node transmits the first synchronization message to the other network nodes at predetermined periodic points in time. A further possibility is to transmit the first synchronization message after having checked if there are multicast groups.

The synchronization master-node is assigned depending on node attributes, wherein the node attributes are a characteristic of a clock or operation status of the node. For example, if the respective node is always in an active status it could be determined to be a synchronization master node within a synchronization domain. Additionally if the characteristic of the clock with a certain node is very accurate it could be determined to be a synchronization master node within a synchronization domain. Furthermore, is a certain node experiences very good communication link quality to all other nodes within a synchronization domain, it could be chosen as synchronization master for this synchronization domain.

According to a further aspect of the present invention the synchronization master-node within synchronization domain may be automatically assigned to a data stream source, wherein the data stream renderers are the synchronization slave nodes.

It is advantageously to activate the synchronization domain for the time of actively running a data stream only. So there will be enough flexibility within the WLAN to set up new synchronization domains depending on new server-renderer relations.

In a further preferred embodiment of the invention, the object is also solved by a communication system including a central network master-node and a plurality of synchronization domains, wherein each synchronization domain includes a synchronization master-node and at least one synchronization slave-node, wherein each node comprises a clock and a clock register, the central network master-node comprises means for transmitting a first synchronization message and means for supporting multicast communication, the synchronization master-node and the at least one synchronization slave-node of a synchronization domain are arranged for capturing their local clock value after receiving a first synchronization message from the central network master node, wherein the synchronization master-node is adapted to transmit its local clock value to the at least one synchronization slave node within its synchronization domain, wherein a synchronization slave-node includes means for receiving a clock value and for comparing the captured local clock value with the received clock value from its assigned synchronization master node, wherein the slave-node's clock is updated depending on the comparison result.

For foregoing features of the present invention will become more readily apparent and may be understood by referring to the following detailed description of an illustrative embodiment of the present invention, taken into conjunction with the accompanying drawings, where:

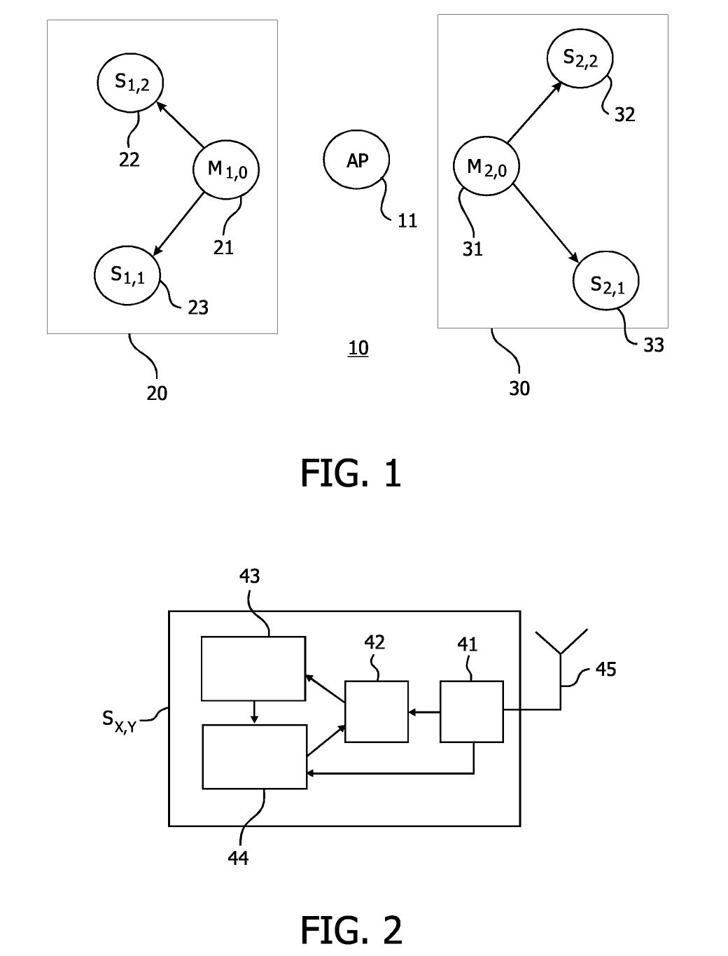

FIG. 1 illustrates an exemplary WLAN (802.11) including a central master-node and several synchronization domains according to the present invention;

FIG. 2 shows an exemplary slave node used within a WLAN according to the present invention;

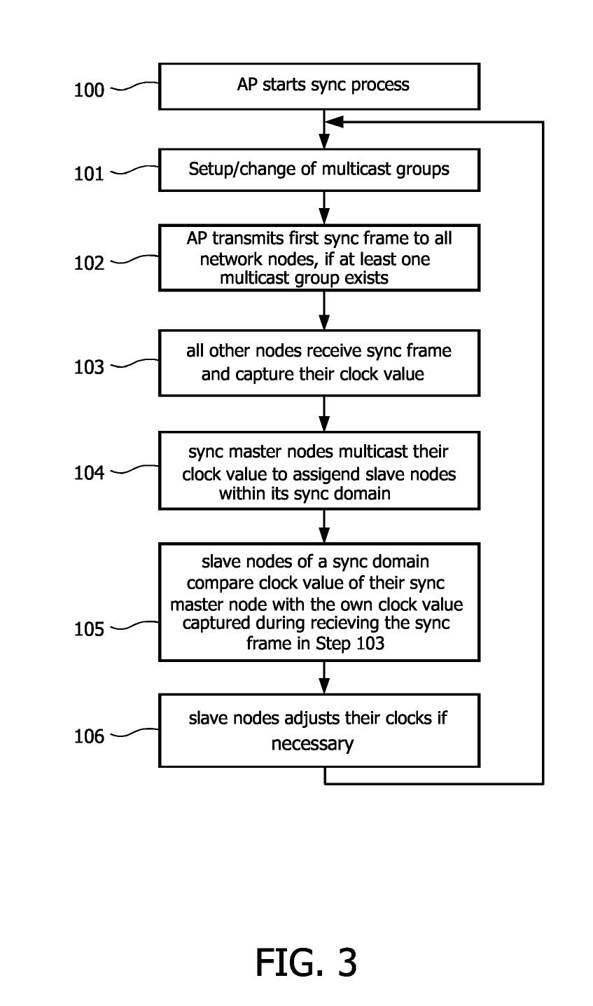

FIG. 3 illustrates a flow chart for synchronizing the network nodes;

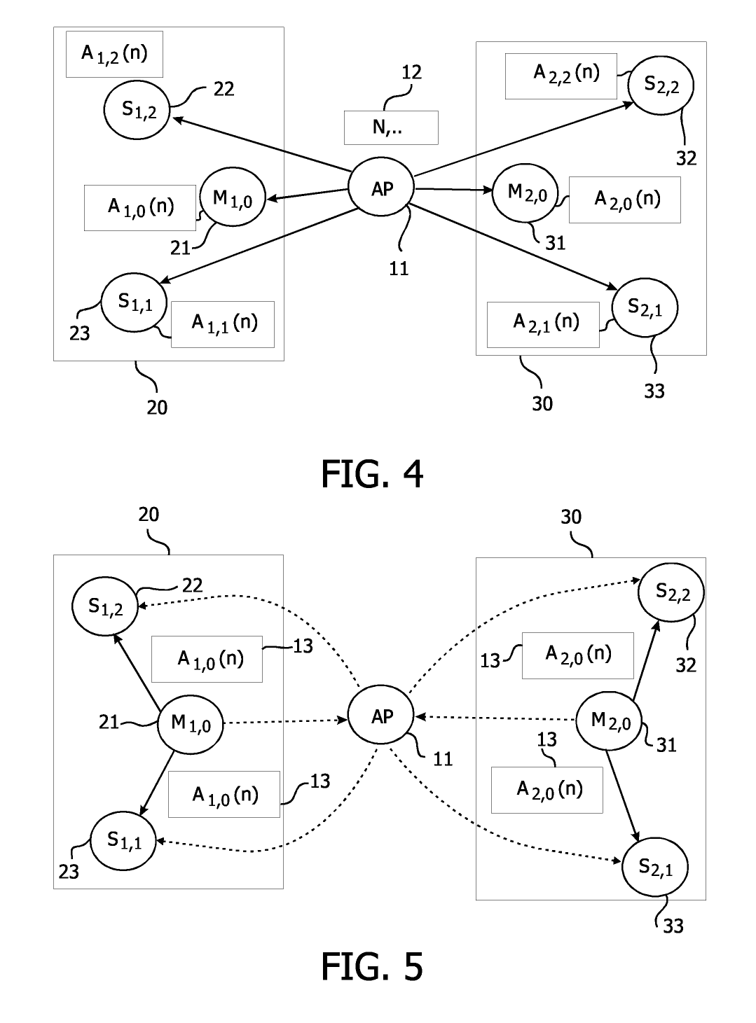

FIG. 4 shows a first status when the central master-node transmits the first synchronization frame;

FIG. 5 shows a following status when the synchronization master nodes multicast their captured clock values to the slave nodes;

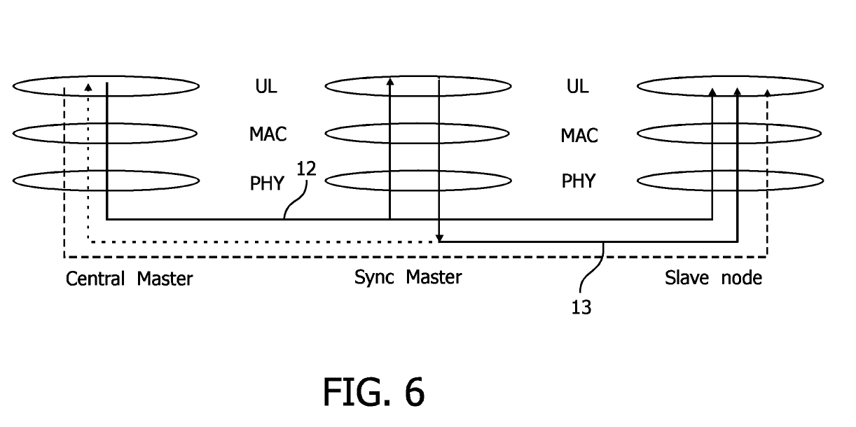

FIG. 6 shows a schematic model of the layers used for transmitting the required synchronizations frames

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

The present invention is described below in the context of synchronizing wireless nodes 21, 22, 23, 31, 32, 33 via an 802.11 wireless LAN. However, it is to be appreciated that the teachings of the invention discussed herein are not so limited. That is, the invention is applicable to any communication system, wired or wireless, that requires stringent synchronization as defined herein. For example, the present invention has applicability to wired communication systems, such as IEEE 802.3 and Ethernet.

With reference now to the figures, and in particular with reference to FIG. 1, an IEEE 802.11 wireless network 10, in which a preferred embodiment of the present invention may be implemented, is depicted.

In FIG. 1, AP denotes the 802.11 “Access point”, i.e. the central master-node 11 of the network 10 that manages the network for all non-central master-nodes 21-33 in the WLAN; a particular such management function is scheduling access of network nodes to the medium, as e.g. executing the so-called point-coordination function as specified in the 802.11 Standard, or the so-called hybrid coordination function as specified in the 802.11e Standard. M_{x,0} denotes the synchronization master-node 21, 31 of synchronization domain ‘x’. S_{x,y} denotes synchronization slave node ‘y’ of synchronization domain ‘x’. As shown, the network 10, includes several nodes 11, 21-23, 31-33 which are realized as mobile stations, wherein the node 11 is the access point AP. This central master node 11 could be realized also as hybrid coordinator HC in accordance with the 802.11e Standard. All mobile stations 21-33 needs to be registered at (i.e. associated with) the AP 11. Within the 802.11e Standard the mobile stations 21-33 transmit their traffic specification (TSPEC). This traffic specification (TSPEC) includes information of the required bandwidth, latency and further characteristics of the stream to be transmitted. Depending on the TSPEC the AP 11 coordinates the priorities within the network to guarantee a throughput time for real time data. The AP 11 has the highest priority within the network 10. Further it knows the existence of all participating nodes 21-33.

A further characteristic of the invention is the existence of several synchronization domains 20, 30. A synchronization domain 20, 30 is set up before a data stream is transmitted from the sender to the receiver or from the server to the renderer. In the illustrated embodiment the node (M_{1,0}) 21 is the server or data source, wherein the nodes 22 and 23 are the receiving nodes or renderers. In the following the node (M_{1,0}) 21 is designated as synchronization master node (M_{1,0}) 21, wherein the receiving nodes are the synchronization slave nodes (S_{1,1}, S_{1,2}) 23 and 22. The same applies for the second synchronization domain 30 correspondingly.

It is not illustrated, but the assigning of the function as synchronization master-node and slave-nodes could be performed on different attributes of the nodes. For example, the nodes within the network 10 having the most accurate clocks are preferred set as synchronization master nodes. Further the duration of the active state could be used for assigning the synchronization master node function. This determination is achieved by using protocols in layers higher than the MAC layer of the OSI model.

A basic thought of the invention is that it is possible within a wireless network to have several synchronization domains 20, 30 which need not be synchronized against each other. E.g. there is no synchronized interaction between the nodes in different synchronization domains, e.g. node 22 and 32 may communicate in asynchronous fashion but are not involved in a common streaming session, so no synchronization is required between them.

The only connection between different synchronization domains 20, 30 could be made via the central master-node 11. However it is possible that a slave node 22, 23, 32, 33 is deactivated and signed off from a first synchronization domain 20 and is applying and registering within the second synchronization domain 30. The central master-node 11 will be informed to change the allocation of the respective slave node for setting up or changing the multicasting group.

FIG. 2 illustrates an exemplary slave mode S_{x,y} in more detail. A PDA, a mobile phone or portable video display could act as slave node S_{x,y}, wherein the slave node S_{x,y} is receiving a data stream from the master node M_{x,o} within the respective synchronization domain x.

The slave node S_{x,y} includes general functions depending on the kind of device. E.g. a portable video display includes a transceiving section 41, antenna 45, baseband controller, DSP, video decoder, display device, input device (e.g. keyboard) etc. The illustration of the components is omitted to point out the components required for embodying the invention. The transceiving section 41 is coupled with a comparing section 42. Further there is a clock section 43 providing the clock function for the slave node S_{x,y}. A clock register 44 is provided for storing a clock value upon receiving of synchronization messages.

FIG. 3 illustrates a flowchart of the inventive method. At step 100 the synchronization procedure is started within the central master-node 11, e.g. as part of the power-up procedure. This means that in regular intervals of time, the central master node 11 transmits the first synchronization message. This can easily be achieved by running a timer function on the central master node 11, which in suitable time intervals (e.g. 500 milliseconds or several seconds, depending on the accuracy of the clocks in the network nodes) triggers the central master node 11 to transmit the first synchronization message. The suitable time interval may as well be negotiated between the central master node and the synchronization masters.

The first and second synchronization messages are transmitted by using frames transmitted by the central master node or the synchronization master node.

Before starting any stream transmissions, the at least one multicast group needs to be set up in step 101. For each synchronization domain 20, 30 one multicast group is defined. Each multicast group contains the MAC addresses of the nodes within a synchronization domain 20, 30. By multicasting a message from a sender all nodes having an MAC address corresponding to address of the multicast group will receive the message. Multicast groups may be defined at any time before and while the synchronization process is running; nevertheless, they should be defined before streaming in the associated synchronization domain is started. Multicast groups may also be deleted at any time. For simplicity, step 101 is shown in FIG. 3 at the beginning of the loop of the flow chart, but it could be placed at any location within the loop, and could also be executed once before the loop starts.

Once the synchronization procedure is started on the central master-node 11, it is transmitting a first synchronization frame 12 (illustrated in FIG. 3) at time n to all non-central master nodes 21-33 within the WLAN in step 102; time n is determined such that the aforementioned timer is elapsed within central master node 11. The central master-node 11 knows all other network nodes 21-33, since all other network nodes 21-33 need to be registered at the central master-node 11. Transmitting the first synchronization frame 12 from the central master-node 11 could be performed by broadcasting the first synchronization frame 12 to all other network-nodes 21-33. After it has sent the first synchronization frame, the central master node 11 resets its time function, such that after the time function elapses again, time n+1 has come, and a subsequent first synchronization frame needs to be transmitted by the central master node. Optionally, the central master node 11 checks whether any multicast groups have been set up at all; only if at least one such multicast group has been set up, it transmits a first synchronization frame. This avoids unnecessary first synchronization frames 12 to be transmitted in the network.

The first synchronization frame 12 is received by all other network nodes 21-33 in step 103. Upon receiving the first synchronization frame 12 at time n the non-central master-nodes 21-33 capture their current local clock value. In particular all nodes 21-33 capture the time of their local clock upon the occurrence of the last symbol on air (LSOA) of this first synchronization frame 12. The synchronization master-nodes 21, 31 create a message A_{x,0}(n) containing a time snapshot of the local clock value. The synchronization slave nodes 22, 23, 32, 33 create a time stamp A_{x,y}(n) which contains the time snapshot in domain ‘x’, taken by slave node ‘y’ (if ‘y=0’, this denotes the synchronization master M_{x,0} of this domain) at frame ‘n’, and store this time stamp A_{x,y}(n) in their clock register.

In the next step 104 the synchronization master-nodes (M_{1,0}, M_{2,0}) 21, 31 of the synchronization domains 20, 30 multicast their messages A_{x,0}(n) to the slave nodes 22, 23, 32, 33 of their synchronization domain 20, 30. This message A_{x,0}(n) includes the local clock value of the respective synchronization master nodes (M_{1,0}, M_{2,0}) 21, 31 captured at receiving the LSOA of the first synchronization frame 12.

The slave nodes 22 and 23 will receive the clock value of their synchronization master node (M_{1,0}) 21, wherein the slave nodes 32 and 33 within the second synchronization domain 30 will receive the clock value of their synchronization master nodes (M_{2,0}) 31.

Upon receiving the second synchronization frame 13 in the slave nodes 22, 23, 32, 33, the received clock value of the synchronization master node 21, 31 will be compared with the stored local clock value of the slave node captured upon receiving the first synchronization frame 12 in step 105. If there is a time difference larger than a certain threshold, the local clock will be adjusted in step 106 based on the received clock value of its synchronization master node 21, 31. So the nodes within a synchronization domain 20, 30 are synchronized against each other, wherein the synchronization time base of the synchronization master is used.

The synchronization procedure enters then a loop spanning from step 102 to 106, i.e. after step 106 is completed, the AP (central master node) 11 waits for its timer function to elapse, and then broadcasts its next first synchronization frame at time n+1.

It needs to be stated again that the flow chart depicted in FIG. 3 is just an example: specifically, the process of adjusting clocks in synchronization slaves is not required to be completed before the next synchronization loop is executed; instead, an update of the adjustment process takes place once a new second synchronization frame 13 has been received. Similarly, multicast groups may be changed at any time.

Referring to the FIGS. 4-5, the steps of synchronization are described in more detail. FIG. 4 illustrates the situation at the moment of transmitting the first synchronization frame 12. This first synchronization frame 12 could be empty. It could be considered as a synchronization command sent out by the central master-node 11. After receiving the first synchronization frame 12, all non-central master nodes 21-33 within the synchronization domains 20, 30 capture their local clock value. This local clock value could be stored in the clock register 44 of the node. However the simplicity of the inventive method is that only the synchronization master nodes 21, 31 multicast their local clock value in the message A_{1,0}(n) to the associated slave nodes 22, 23, 32, 33 (FIG. 5).

As depicted by the full line arrows in FIG. 5, the second synchronization frame 13 is directly multicasted by the synchronization master-nodes 21, 31 to the associated slave nodes 22, 23, 32, 33 within the synchronization domain 20, 30. Direct multicasting differs from the basic multicast function as available in the 802.11 Standard: instead of sending a multicast message from the message source to the AP, and let the AP distribute this message to all multicast receivers in the multicast group, the message source (i.e. a synchronization master-node) directly transmits the multicast message to the respective receivers (the associated synchronization slave-nodes). The basic solution (no direct multicast) is depicted by using the dashed arrows in FIG. 5. Since the possibility of direct multicasting a message does not exist in all networks, the synchronization master nodes 21, 31 in this basic case transmit the second synchronization frame 13 at first to the central master-node 11. The central master-node 11 then forwards the second synchronization frame 13 to the respective slave nodes 22, 23, 32, 33. Due to the MAC addresses used for multicasting, the slave nodes of a certain synchronization domain will receive only the second synchronization frame 13 having clock value of the associated synchronization master node 21, 31.

FIG. 6 roughly illustrates a schematic of a layer model used for the invention. Each service within the nodes is organized in layers. Therein the physical layer PHY provides the physical channel. The Mac layer MAC above the physical layer PHY provides the addressing of data packets to be transmitted and received, e.g. SDUs or PDUs, and organizes the nodes' access to the medium. Above the Mac layer MAC there are several higher or upper layer UL, e.g. RRC, RLC, NW, TRSP etc. up to the application layer. Within these layers UL, the start of the synchronization is initiated. Further they are responsible for setting up and change the multicast groups.

The invention provides a method and a communication network allowing a smart synchronization solution without stringent signaling. Only the nodes which need to be synchronized will be synchronized with each other. Nodes having no synchronization requirements with each other (e.g. no streaming ongoing among them) are not synchronized.

1. Method for synchronization of network nodes in a local area network (10) including a central network master-node (11) and a plurality of synchronization domains (20, 30), each synchronization domain (20, 30) includes a synchronization master-node (21, 31) and at least one synchronization slave-node (22, 23; 32, 33), the method comprising the following steps:
setting up or changing a multicast group for each synchronization domain (20, 30), wherein a multicast group includes MAC addresses of all synchronization slaves (22, 23; 32, 33) of the synchronization domain (20, 30);
transmitting a first synchronization message (12) at time n from the central master-node (11) to all other network nodes (21, 22, 23; 31, 32, 33);
receiving the first synchronization message in all other network nodes (21, 22, 23; 31, 32, 33);
capturing a local clock value A_{x,y}(n) at receiving the first synchronization message (12) in each other network nodes (21, 22, 23; 31, 32, 33);
multicasting a second synchronization message (13) by the synchronization master-nodes (21, 31) to the synchronization slaves-nodes (22, 23; 32, 33) at time n+x within the associated synchronization domain (20, 30), wherein the second synchronization message (13) includes the local clock value A_{x,0}(n) of the associated synchronization master-node (21, 31) of the synchronization slave-nodes (22, 23; 32, 33) within the respective synchronization domain (20, 30);
receiving the second synchronization message (13) in the synchronization slave-nodes (22, 23; 32, 33) including the clock value A_{x,0}(n) of the associated synchronization master-node (21, 31);
comparing the local clock value A_{x,y}(n) captured at receiving of the first synchronization message (12) with the clock value A_{x,0}(n) received with the second synchronization message (13); and
adjusting the local clock in the synchronization slave-node (22, 23; 32, 33) depending on the comparison result.

2. Method as claimed in claim 1, wherein the capturing of local clock values A_{x,y} is performed upon occurrence of last symbol on air (LSOA).

3. Method as claimed in claim 1, comprising the step:
creating a time snapshot message including the captured local clock value A_{x,y}(n) in each non-central master-node (21, 22, 23; 31, 32, 33) upon receiving the first synchronization message (12);
multicasting the time snapshot message including the locale clock value A_{x,0}(n) from all synchronization master-nodes (21, 31) to the synchronization slaves (22, 23, 32, 33) within the synchronization domain (20, 30) of the corresponding synchronization master-nodes (21, 31);

4. Method as claimed in claim 1, including the step of: transmitting the first synchronization message (12) from the central master node (11) to all other network nodes (21, 22, 23; 31, 32, 33) at a predetermined periodic point in time or only if a multicast group exists.

5. Method as claimed in claim 1, wherein the synchronization master-node (21, 31) is determined depending on node attributes, wherein node attributes are at least one of the characteristics of a clock and the condition of an on-status.

6. Method as claimed in claim 1, wherein the first synchronization message (12) is transmitted by broadcasting the first synchronization message (12) from the central master node (11) to all other nodes (21-33).

7. Method as claimed in claim 1, wherein the synchronization master-node (21, 31) is automatically assigned to a data stream source, wherein the data stream renderers are the synchronization slave nodes (22, 23, 32, 33).

8. Method as claimed in claim 1, wherein the synchronization domain (20, 30) is activated for the time of actively running a data stream.

9. Method as claimed in claim 1, wherein for the multicasting step each synchronization master node (21, 31) transmits a second synchronization message (13) including its local clock value A_{x,0}(n) to the central master node (11), which distributes the second synchronization message (13) to the associated synchronization slaves (22, 23, 32, 33) of the respective transmitting synchronization master node (21, 31).

10. Communication network including:
a central master-node (11) of the network and
a plurality of synchronization domains (20, 30) and
means for setting up a multicasting group for each synchronization domain (20, 30), wherein a multicast group includes MAC addresses of all synchronization slaves (22, 23; 32, 33) of the synchronization domain (20, 30);
each synchronization domain (20, 30) includes a synchronization master-node (21, 31) and at least one synchronization slave-node (22, 23, 32, 33), wherein each node (21-33) comprises a clock (43) and a clock register (44),
the central master-node (11) comprises means for transmitting a first synchronization message (12),
the non-central master nodes (21-33) are arranged for receiving (41, 45) the first synchronization message (12) and for capturing their local clock values (A_{x,y}(n)) after receiving the first synchronization message (12);
the synchronization master-node (21, 31) is arranged for multicasting a second synchronization message (13) including its local clock value (A_{x,0}(n)) to the associated at least one synchronization slave-node (22, 23, 32, 33) of its synchronization domain (20, 30),
the synchronization slave-node (22, 23, 32, 33) includes means for receiving the second synchronization message (13) and for comparing (42) the captured local clock value (A_{x,y}(n)) with the received clock value (A_{x,0}(n)), wherein the clock (43) is updated depending on the comparison result.
